(19) United States
(12) Patent Application Publication
(10) Pub. No.: US 2014/0270601 A1
(43) Pub. Date: Sep. 18, 2014

(54) ANTI-SKID AND POSITIONING LINEAR RAIL STRUCTURE

(71) Applicant: Chih-Hsin Chen, Changhua (TW)

(72) Inventor: Chih-Hsin Chen, Changhua (TW)

(73) Assignee: GMT GLOBAL INC., Changhua (TW)

(21) Appl. No.: 13/846,551

(22) Filed: Mar. 18, 2013

(51) Int. Cl. F16C 29/00

(52) U.S. Cl. CPC F16C 29/001
USPC 384/15

(57) ABSTRACT

An anti-skid and positioning linear rail structure includes two rail units, a spacing piece, two teeth plates and two covers, wherein said two rails are disposed in a parallel manner, and a first surface is formed on each side of the rails units facing each other, and center of the first surface has a track, and a plurality of slot holes are disposed axially on the spacing piece, so most rolling units are able to be distributed into the slot holes of the spacing piece, and a receiving space is recessedly formed at central portion of one side of the rail unit. Center portion of the teeth plate has a hinged hole with a plurality of protruding teeth at the periphery thereof, and inner surface of the cover has a shaft stick provided for the hinged hole, and a cut opening is formed at the periphery thereof.

### FIELD OF THE INVENTION

The present invention relates to an anti-skid and positioning linear rail structure, and more particularly to a linear rail structure that can be used to control and restrict the distance between two rails to achieve the goal of precisely controlling the movement thereof.

### BACKGROUND OF THE INVENTION

Conventionally, linear rails may include two rail units and one spacing piece disposed therebetween. A plurality of slot holes can be disposed axially on the spacing piece to accommodate multiple rolling units. When in use, the rolling units roll back and forth between two rail units, so the two rail units can generate relative axial movements. However, it is difficult to control and restrict the distance between the rails during movement, so conventional linear rails cannot be used in the situations that require high precision.

A Taiwanese patent (Patent number 552356, filed on Feb. 20th, 2002) issued on Sep. 11, 2003 disclosed a linear rail that can restrict the movement, however, it is still disadvantageous because the small gear and teeth rods are conjugated in the V-groove of the guiding elements, which requires certain designs inside the guiding element and it may significantly increase the production costs.

### SUMMARY OF THE INVENTION

The present invention wants to solve the problems present above to provide includes an anti-skid and positioning linear rail structure having two rail units, a spacing piece, two teeth plates and two covers. The two rails are disposed in a parallel manner, and a first surface is formed on each side of the rails units that faces each other. Center of the first surface has a V-shaped track, and each side of the rails units has a fixed hole with inner threads to conjugate with a stopping unit. Also, a receiving space is recessedly formed at central portion of one side of the rail unit, and one side of the receiving space can pass through the first surface through an opening. A plurality of slot holes are disposed axially on the spacing piece, so most of rolling units can be crossly-distributed into each slot hole of the spacing piece. The spacing piece is disposed between the first surfaces of the rail units and the columnar rolling units can roll back and forth between the tacks of the two rail units, so that the two rail units can generate relative axial movements. Furthermore, a plurality of linear holes are disposed on both sides of the spacing piece parallel to the slot hole. Center portion of the teeth plate has a hinged hole having a plurality of protruding teeth at the periphery thereof. The teeth plate is disposed into the receiving space of the rail units, so that the protruding teeth can be conjugated with the linear holes of the spacing piece through the opening. Inner surface of the cover has a shaft stick provided for the hinged hole of the teeth plate, and a cut opening is formed at the periphery thereof. The cover can seal the receiving space after the teeth plates are disposed in the receiving space to prevent the teeth plates from falling out. Also, the cut opening is working with the opening to provide escape when the protruding teeth of the teeth plates and the linear holes are conjugating.

According to the embodiments described above, the present invention is advantageous because (i) the movement of the linear rail can be restricted, so it can be used in the circumstances that require high precision; (ii) the teeth plates are disposed into the receiving space of one side of the rail units, so the protruding teeth can pass through the opening and cut opening to conjugate with the linear holes of the spacing piece, which does not require extra designs in the rail units, so the product costs can be significantly reduced; (iii) according to the numbers of the linear holes, the spacing piece can be made with various lengths for the teeth plates to easily adjust the length of the movement of two rail units.

### BRIEF DESCRIPTION OF THE DRAWINGS

FIG. 1 illustrates a three-dimensional assembled view of the present invention.

FIG. 2 illustrates a three-dimensional exploded view of the present invention.

FIG. 3 illustrates a two-dimensional assembled view of the present invention.

FIG. 4 illustrates a sectional view of the present invention.

FIG. 5 illustrates a sectional view from another angle of the present invention.

FIG. 6 illustrates a schematic view of movement restriction of the present invention.

### DETAILED DESCRIPTION OF THE INVENTION

The detailed description set forth below is intended as a description of the presently exemplary device provided in accordance with aspects of the present invention and is not intended to represent the only forms in which the present invention may be prepared or utilized. It is to be understood, rather, that the same or equivalent functions and components may be accomplished by different embodiments that are also intended to be encompassed within the spirit and scope of the invention.

Unless defined otherwise, all technical and scientific terms used herein have the same meaning as commonly understood to one of ordinary skill in the art to which this invention belongs. Although any methods, devices and materials similar or equivalent to those described can be used in the practice or testing of the invention, the exemplary methods, devices and materials are now described.

All publications mentioned are incorporated by reference for the purpose of describing and disclosing, for example, the designs and methodologies that are described in the publications that might be used in connection with the presently described invention. The publications listed or discussed above, below and throughout the text are provided solely for their disclosure prior to the filing date of the present application. Nothing herein is to be construed as an admission that the inventors are not entitled to antedate such disclosure by virtue of prior invention.

In order to further understand the goal, characteristics and effect of the present invention, a number of embodiments along with the drawings are illustrated as following:

Referring to FIGS. 1 to 5, the present invention includes two rail units (10), a spacing piece (20), two teeth plates (30) and two covers (40). The two rails are disposed in a parallel manner, and a first surface (11) is formed on each side of the rails units (10) that faces each other. Center of the first surface (11) has a V-shaped track (12), and each side of the rails units (10) has a fixed hole (13) with inner threads to conjugate with a stopping unit (14). Also, a receiving space (15) is recessedly formed at central portion of one side of the rail unit (10), and one side of the receiving space (15) can pass through the first surface (11) through an opening (16). A plurality of slot holes (21) are disposed axially on the spacing piece (20), so most rolling units (22) can be crossly-distributed into each slot hole (21) of the spacing piece (20). The spacing piece (20) is disposed between the first surfaces (11) of the rail units (20) and the columnar rolling units (22) can roll back and forth between the tacks (12) of the two rail units (10), so that the two rail units (10) can generate relative axial movements. Furthermore, a plurality of linear holes (23) are disposed on both sides of the spacing piece (20) parallel to the slot hole (21). Center portion of the teeth plate (30) has a hinged hole (31) having a plurality of protruding teeth (32) at the periphery thereof. The teeth plate (30) is disposed into the receiving space (15) of the rail units (10), so that the protruding teeth (32) can be conjugated with the linear holes (23) of the spacing piece (20) through the opening (16). Inner surface of the cover (40) has a shaft stick (41) provided for the hinged hole (31) of the teeth plate (30), and a cut opening (42) is formed at the periphery thereof. The cover (40) can seal the receiving space (15) after the teeth plates (30) are disposed in the receiving space (15) to prevent the teeth plates (30) from falling out. Also, the cut opening (42) is working with the opening (16) to provide escape when the protruding teeth (32) of the teeth plates (30) and the linear holes (23) are conjugating.

When in use, the linear rails are disposed in a mechanical structure, so the rolling units (22) can roll back and forth between the tracks (12) of two rail units (10) and the two rail units (10) can generate axial movements along with the mechanical structure. During the movement, the protruding teeth (32) of the teeth plates (30) can pass most of the linear holes (23) of the spacing piece (20), so that the teeth plates (30) can be driven to rotate. Till the end of the movement, when the spacing piece (20) cannot continue to provide the linear holes (23) for the protruding teeth (32) to pass (see FIG. 6), the movement stops and the movement can be limited on the linear rails.

According to the embodiments described above, the present invention is advantageous because (i) the movement of the linear rail can be restricted, so it can be used in the circumstances that require high precision; (ii) the teeth plates (30) are disposed into the receiving space (15) of one side of the rail units (10), so the protruding teeth (32) can pass through the opening (16) and cut opening (42) to conjugate with the linear holes (23) of the spacing piece (20), which does not require extra designs in the rail units (10), so the product costs can be significantly reduced; (iii) according to the numbers of the linear holes (23), the spacing piece (20) can be made with various lengths for the teeth plates (30) to easily adjust the length of the movement of two rail units (10).

Having described the invention by the description and illustrations above, it should be understood that these are exemplary of the invention and are not to be considered as limiting. Accordingly, the invention is not to be considered as limited by the foregoing description, but includes any equivalents.

What is claimed is:

1. An anti-skid and positioning linear rail structure comprising two rail units, a spacing piece, two teeth plates and two covers,
wherein said two rails are disposed in a parallel manner, and a first surface is formed on each side of the rails units that faces each other, and center of the first surface has a track, and a plurality of slot holes are disposed axially on the spacing piece, so most rolling units are able to be distributed into the slot holes of the spacing piece,
wherein the spacing piece is disposed between the first surfaces of the rail units and the rolling units roll back and forth between the tacks of the two rail units, so that the two rail units generate relative axial movements,
wherein a receiving space is recessedly formed at central portion of one side of the rail unit, and one side of the receiving space passes through the first surface through an opening, and a plurality of linear holes are disposed on both sides of the spacing piece parallel to the slot hole,
wherein center portion of the teeth plate has a hinged hole has a plurality of protruding teeth at the periphery thereof, and the teeth plate is disposed into the receiving space of the rail units, so that the protruding teeth are able to conjugate with the linear holes of the spacing piece through the opening,
wherein inner surface of the cover has a shaft stick provided for the hinged hole of the teeth plate, and a cut opening is formed at the periphery thereof, and the cover is used to seal the receiving space after the teeth plates are disposed in the receiving space to prevent the teeth plates from falling out, the cut opening is working with the opening to provide escape when the protruding teeth of the teeth plates and the linear holes are conjugating.

2. The anti-skid and positioning linear rail structure of claim 1, wherein each side of the rails units has a fixed hole with inner threads to conjugate with a stopping unit.

3. The anti-skid and positioning linear rail structure of claim 1, wherein said rolling units are crossly-distributed into each slot hole of the spacing piece.

4. The anti-skid and positioning linear rail structure of claim 1, wherein the rolling units are columnar.
